(19) United States
(12) Patent Application Publication
(10) Pub. No.: US 2018/0357857 A1
(43) Pub. Date: Dec. 13, 2018

(54) Live-Event Betting System Having Strategic Bets Placed by the House

(71) Applicants: Burton SIMON, Silverthorne, CO (US); Tracy ERICSON, Collinsville, CT (US)

(72) Inventors: Burton SIMON, Silverthorne, CO (US); Tracy ERICSON, Collinsville, CT (US)

(21) Appl. No.: 15/621,927

(22) Filed: Jun. 13, 2017

(51) Int. Cl. G07F 17/32

(52) U.S. Cl. CPC G07F 17/3244; G06Q 50/34; G07F 17/32; G07F 17/3288

(57) ABSTRACT

An in-progress sports betting system able to provide improved estimated payoff odds for non-fixed betting odds, where the house places bets along with players. The system may include an artificial intelligence (AI) unit designed to estimate real-time probabilities of outcomes associated with live events, and a host computer able to accept bets from players, place bets on behalf of the house based on the AI estimates, maintain a detailed electronic record on all betting activity (including house betting activity), estimate and post up-to-date payoff odds based on the electronic record, and distribute payoffs on wining bets when the betting events terminate. The purpose of the house bets is to continuously and strategically adjust the real-time posted payoff odds and/or to create additional revenue for the house. Players can communicate with the host computer and place bets through physical devices, such as mobile electronic devices, personal computers, or stationary kiosks.

### FIELD OF THE INVENTION

The present invention is directed towards a betting system and methods of operating a betting system. In particular, the present invention describes a live-event betting system where the house takes an active role in placing bets in addition to the usual roles of posting current odds, collecting bets, and distributing payoffs to winners.

### BACKGROUND OF THE INVENTION

Most sports betting systems use fixed odds betting where the house (i.e., the organization operating the betting system) posts the payoff odds on the available choices, and winning players that place a bet while the line is open are guaranteed a payoff consistent with the posted odds. Fixed odds betting is very common today with football, baseball, basketball, hockey, soccer, golf, tennis, and most other popular sport events. However, a few sports, like horse racing, dog racing, and jai alai, typically use pari-mutuel betting systems. In a pari-mutuel betting system, players are essentially betting against other players in that the odds paid on a winning bet depend on the sizes of the betting pools on each choice when the betting line closes. As a result, the odds paid on a winning bet will change over time as more bets are placed and may be different from the posted odds at the time a particular player places a bet. There are also sports betting systems modeled on financial markets (e.g., prediction markets) where one “share” of a betting choice is worth a fixed amount if that choice wins, and the profit on a winning share depends on the price paid by the player.

As used herein, the “ultimate payoff odds” on a bet is the ratio of the amount a winning player wins (in profit) to the amount of the bet. So, for example, if a player bet $10 and received $100 after winning the bet, then the ultimate payoff odds on that bet was 9:1 ($90 profit versus the initial bet of $10). In general, if the probability that a given choice will be the winning choice is 1/(m+1), and if the house pays m:1 on that choice, then the bet is exactly even, i.e. (1/(m+1))*(B*m)=(m/(m+1))*(B).

Players obviously want to know how much profit they stand to make on a bet before they make the bet. The “posted payoff odds” on the betting choices are typically the only information provided by the house. In an honest sports betting system, the posted payoff odds are good-faith estimates of the ultimate payoff odds. In fixed odds betting, the posted odds on the choices at the time of a bet are exactly the ultimate payoff odds if that choice wins. This is also generally true in prediction market sports betting (even though it is usually not described this way). The posted payoff odds on a choice can be calculated from the asking price: it is the reciprocal of the asking price of a $1 share, minus 1. Even in this instance, as with fixed odds betting, the player knows at the time of the bet exactly how much profit will be earned if the bet wins.

Pari-mutuel betting is different in that the ultimate payoff odds will be the ratio of the total money bet on all the choices to the total money bet on the winning choice while the line was open. At time t the posted odds on choice k is the ratio of the total money bet on all the choices up to time t to the total money bet on k up to time t. In general, the posted odds will change over time, so the posted odds on a choice at the time of a bet may not be the same as the ultimate payoff odds on that choice if it wins. As a result, the time when a bet is placed does not affect the final payoff odds. Pari-mutuel betting systems and other non-fixed odds systems can therefore be problematic in that players may prefer betting systems where the payoff odds will not change after the bet has been made. Several pari-mutuel betting systems have attempted to address this issue by providing multiple independent pari-mutuel betting pools for the same betting event (see for example U.S. Pat. No. 7,454,380 and U.S. Pat. No. 7,740,539). However, the odds for each betting pool will still change over time and can lead to unbalanced payoffs for the same bet which may problematic for the players as well as the house.

The present invention is similar to pari-mutuel betting in that the ultimate payoff odds may not be the same as the posted odds at the time of a bet. However the present invention is different from pari-mutuel betting since both the ultimate payoff odds and the posted payoff odds are computed differently, and crucially, in the present invention the ultimate payoff odds on a bet depend on when the bet is placed, and furthermore the house purposely attempts to adjust and control the posted payoff odds during the betting event by making its own bets.

### SUMMARY OF THE INVENTION

Within the categories of fixed odds, pari-mutuel, and prediction market sports betting, there are a number of variations and enhancements in the prior art. However the present invention provides a live-event betting system with a new way to provide posted payoff odds and calculate ultimate payoff odds, wherein the house places bets in order to adjust and control the posted payoff odds. Such a system is therefore not a fixed odds system, pari-mutuel system, prediction market system, nor any variant of those systems disclosed in the prior art.

In an embodiment, the present invention provides a betting system, preferably for live sporting events, able to provide improved estimated payoff odds for non-fixed betting odds, where the house places bets along with players. The system includes an artificial intelligence (AI) designed to estimate real-time probabilities of outcomes associated with live events, and a host computer able to accept bets from players, place bets on behalf of the house based on the AI estimates, maintain a detailed electronic record on all betting activity (including house betting activity), estimate and post up-to-date payoff odds based on the electronic record, and distribute payoffs on wining bets when the betting events terminate. The purpose of the house bets is to continuously and strategically adjust the real-time posted payoff odds and/or to create additional revenue for the house. Players can communicate with the host computer and place bets through physical devices, such as mobile electronic devices, personal computers, or stationary kiosks.

Betting occurs before and/or during a betting event such as an individual game, a drive during in a football game, an inning in a baseball game, a set in a tennis match, one or more games during a knockout tournament like March Madness or the Stanley Cup playoffs, or a Fantasy Sports contest. Betting events can also be based on non-sporting events like eSports contests, award shows, reality shows, and elections. One or more betting lines are provided for each betting event, where there is a set of betting choices (i.e., possible outcomes of the betting event) that players can bet on while the betting line is open. The betting choices are preferably mutually exclusive, i.e., no more than one of them will be the winning choice. Players can bet whenever they want and as much as they want, subject to house rules. (By house rules, there may be intervals of time during the betting event when betting is paused; for example, bets may not be allowed during the actual plays in a football game, or during points in a tennis match.) All payoffs are made after the betting event terminates.

At certain times during the betting event the house can also make bets. The precise betting times, betting choices, and betting amounts for the house are determined by fixed algorithms based on all the information available to the house, which includes the current probabilities that each of the betting choices will prevail as estimated by the AI, and an electronic record (such as a spreadsheet) that lists the details of every bet made up to the present by players and the house. House bets are typically in exact proportion to the estimated probabilities of the outcomes, because this can be shown mathematically to minimize the risk to the house, although there are preferred embodiments where other rules apply. House bets have the same status and effects on payoff outcomes as bets placed by the players.

In an embodiment, a host computer creates and maintains a detailed electronic record (also referred to herein as the BetLog) of every bet made by the players and the house during the betting event. The house chooses an algorithm that uses the data in the record to determine the payoffs on winning bets, and discloses the algorithm in advance so the players understand the rules. In a further embodiment, the host computer continuously uses the most up-to-date betting data from the electronic record to estimate and post the payoff odds that will be paid on winning bets made at that time. The posted payoff odds are good faith estimates of the ultimate payoff odds, but are not guaranteed to be exact. The exact details of the algorithms for determining the payoff amounts and estimating payoff odds are adjustable depending on the particular desired application of the system.

In an embodiment, the present invention provides a method of providing a betting system between a plurality of players and a house, wherein the betting system is based on a live event. The method comprises the steps of: a) providing one or more selectable betting events to the players, wherein each betting event is based on actions occurring during a live event; b) opening one or more betting lines for each selected betting event before the start or after the start of the live event but before a termination event occurs with regard to the betting event, each betting line comprising two or more mutually exclusive betting choices corresponding to a finite set of possible outcomes of the selected betting event; c) allowing the players an amount of time while the betting line is open to selectively bet on the betting lines; d) at one or more time periods, placing a house bet on one or more betting choices of a selected betting line, wherein each house bet is in an amount that is able to be the same or different from one another, and wherein the time period to make the house bets for the selected betting line is determined using a first predetermined algorithm and the amount of each house bet is determined using a second predetermined algorithm (preferably obtained from an AI feed); e) during the time when players are allowed to bet on the betting lines, calculating estimated payoff odds using a third predetermined algorithm based on placed bet data and posting the estimated payoff odds to the players; f) monitoring the live event until a termination event occurs with regard to the betting event; g) terminating the betting event upon occurrence of the termination event; and h) upon termination of the betting event, paying off winners of the one or more betting lines according to a fourth predetermined algorithm, based on the amount wagered on the betting line and the precise time of the bet, wherein winning house bets are paid to a house account.

Preferably, the first and second algorithms are automatically performed and administered using an artificial intelligence (AI) and data needed for said algorithms are automatically obtained from an AI feed monitoring the live event, betting lines and placed bets.

Preferably, the house bets are simultaneously placed on each of the betting choices of a selected betting line, and the house bet amount for each choice is proportional to a current estimated probability (as determined by the AI feed) of that choice becoming a winning choice. In a further embodiment, the house bets are placed at time periods {t₁, t₂, . . . , tₙ} which are determined in real time by a first predetermined algorithm based on the AI feed and previously placed bet data as recorded in an electronic spreadsheet (also referred to herein as the BetLog). With regard to the estimated posted odds, the posted odds on a choice r at a time t can be calculated from all bets placed from the last time the house made a bet, up to time t; and the payoff on a winning bet placed at time t depends on all bets placed between the last time the house bet before t and the next time the house bets after t, or when the betting event terminates. Optionally, the house bets are placed at the beginning of the betting event and then the house does not bet again, and where the posted odds on choice k at time t is calculated from the all bets (player and house bets) placed up to time t, and the actual payoff on a winning bet placed at time t is the same as the posted odds at time t taking said bet into account.

Optionally, the betting event is a live sports event including, but not limited to, a half-inning in a baseball game, an at-bat in a baseball game, a drive in a football game, a set of downs in a football game, a k-game football parlay, and a set in a tennis match. For football drives and sets of downs, the betting choices include touchdowns, field goals, punts, and turnovers, and for a k-game football parlay the betting choices are the 2^{k} possible winning and losing combinations. In every case the betting choices are preferably mutually exclusive so that exactly one choice wins every time.

In an embodiment, the invention provides a system for providing a betting game between a plurality of players, where the betting game is based on actions occurring during a live event, and where said system is under the control of a fully autonomous administrator (the host processor). The system comprises a host processor programmed for analyzing and processing input data, and outputting data and information relevant to the betting game. The host processor is programmed to:

i) provide one or more selectable betting events to the associated with a live event, wherein each betting event is based on actions occurring during said live event;

ii) open one or more betting lines for each selected betting event before the start or after the start of the live event but before a termination event occurs with regard to the betting event, each betting line comprising two or more mutually exclusive betting choices corresponding to a finite set of possible outcomes of the selected betting event;

iii) allow the players an amount of time before or during the betting event to selectively bet on the betting lines;

iv) at one or more time periods, place a house bet on one or more betting choices of a selected betting line, wherein each house bet is in an amount that is able to be the same or different from one another, and wherein the time period to make the house bets for the selected betting line is determined using a first predetermined algorithm and the amount of each house bet is determined using a second predetermined algorithm;

v) during the time when players are allowed to bet on the betting lines, calculate estimated payoff odds using a third predetermined algorithm based on placed bet data and posting said estimated payoff odds to the players;

vii) monitor the live event until a termination event occurs with regard to the betting event;

viii) terminate the betting event upon occurrence of the termination event; and

ix) upon termination of the betting event, pay of the one or more betting lines according to a fourth predetermined algorithm, based on the amount wagered on the betting line and the precise time of the bet, wherein winning house bets are paid to a house account.

In a further embodiment, the system further comprises an artificial intelligence (AI) able to automatically feed data collected from one or more live events and historical events to the host computer so it can administer the first and second predetermined algorithms.

In a further embodiment, the system further comprises a plurality of player processors interactively connected to the host processor, where each player processor is able to send and receive data to the host processor. Optionally, a display and interface device operatively associated with each player processor is part of the system, where the display and interface device able to display data received from the player processor, and is able to send betting instructions entered by the player to the host processor through the player processor.

In an embodiment, a host computer creates and maintains a detailed electronic record (also referred to herein as the BetLog) of every bet made by the players and the house during the betting event. Preferably, the host processor is fully autonomous, with connections to the AI feed and control of the BetLog.

### BRIEF DESCRIPTION OF THE DRAWINGS

FIG. 1 shows a diagram of a host processor able to send and receive information in one embodiment of the invention.

FIG. 2 shows a flow chart of steps taken by a betting system of the present invention involving allowing players to place bets, placing house bets, posting payoff odds, terminating the betting event, and calculating the payoff amounts. The purposes and relationships between four predetermined algorithms used to administer the betting system in certain embodiments are also illustrated.

### DETAILED DESCRIPTION OF THE INVENTION

### Definitions

As used to describe the present invention, the following terms are defined as follows.

The “house” is the generic name for the person or entity administering the betting system of the present invention. The house may be a bricks and mortar casino or business, or may be a web site on the internet. A “player” is someone other than the house who is participating and placing bets on a betting event.

A “live event” refers to a sporting event or any other unpredictable event that that proceeds over time with an unambiguous beginning and end, including but not limited to traditional sporting events, eSports events, an election, a stock price during some period of time, trivia game, awards show, and an episode of a reality television show. A “sporting event” is an athletic contest of some sort, including but not limited to a football game, baseball game, basketball game, hockey game, tennis match, golf tournament, race, Olympic event, boxing match, martial art fight, and wrestling match. A “live sporting event” is a sporting event that is occurring in the present. Additionally, a live sporting event can include a prerecorded sporting event where the players do not know anything about the outcome or events that took place during the event.

A “betting event” is a selectable item provided by the betting system corresponding to actions occurring during a live event whereby players of the betting system can select the betting event and place bets on the different possible outcomes of the selected betting event.

A “betting line” is a selectable item corresponding to possible actions and scenarios that can occur in the betting event. “Betting choices” are the possible outcomes of a selected betting line. Each betting line will have two or more betting choices corresponding to a finite set of possible outcomes of the selected betting event. For example, for a traditional betting event (i.e., “who will win the game?”) the betting line may have the choices: Team A wins, or Team B wins. If the betting event is a drive in a football game then the betting line may have the choices: Touchdown, Field Goal, Punt, or Turnover. By opening a betting line, it meant the players are allowed to bet on the possible outcomes of the selected betting event. By terminating a betting line it, is meant the outcome of a selected betting line has been determined and it possible to pay the winners of the betting line according to house rules.

“House bets” refer to the money, tokens, chips or credits placed in a betting line by the house for any reason. Possible reasons include making additional revenue for the house, or setting or stabilizing the posted odds. The house bets may be placed at a single time during the live event, or at multiple times during the live event, as determined by a predetermined algorithm.

As used herein, an “artificial intelligence” or “AI” is any software system that has access to past data related to the live event (such as historical sports data) and access to a real time description of everything happening in the current live event, and can automatically produce real time estimates of the probabilities that each of the n choices in a given betting line will win.

A simple example of such an AI in one embodiment would search historical data for game situation similar to the game situation in a present live sporting event. If there were M such historical situations, and choice r prevailed in m of them, then the AI would estimate the probability that r wins by m/M. Of course, more sophisticated AI programs could also be utilized.

The “artificial intelligence feed” or “AI feed” is the resulting continuous stream of data generated by the AI: pₜ=(pₜ(1), . . . , pₜ(n)), t≥0, where pₜ is the vector of win probabilities associated with the n betting choices at time t. The time variable, t, is typically the elapsed (real) time since the betting line opened.

The “BetLog” is an electronic record, spreadsheet, or list generated while a betting line is open, specifying every bet made, including bets made by players and by the house. There is a separate entry in the BetLog for each bet made. Each entry contains five fields, {k, t, m, c, b}, where k=1, 2, . . . , is the bet number, t is the exact time the k^{th} bet is made, m is an identifier for who made the k^{th} bet (e.g., m=1, 2, . . . , which identify different players, and m=0 is the house), c∈{1, . . . , n} is the k^{th} choice, and b is the size of the k^{th} bet.

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

### Overview

The present invention provides a betting system, and methods for administrating a betting system, for a live event where the house is able to place bets on the possible choices along with the players. The payoff amounts for winning choices are determined based on the timing and amounts of all the bets as collected in the electronic betting spreadsheet (also referred to herein as the BetLog) by a predetermined algorithm. In certain embodiments, one or more predetermined algorithms also determine when the house can place bets and the amounts of each house bet. Typically, the house bets are used to stabilize the payoff odds and are in proportion to the estimated probabilities of the betting choices becoming winning betting choices.

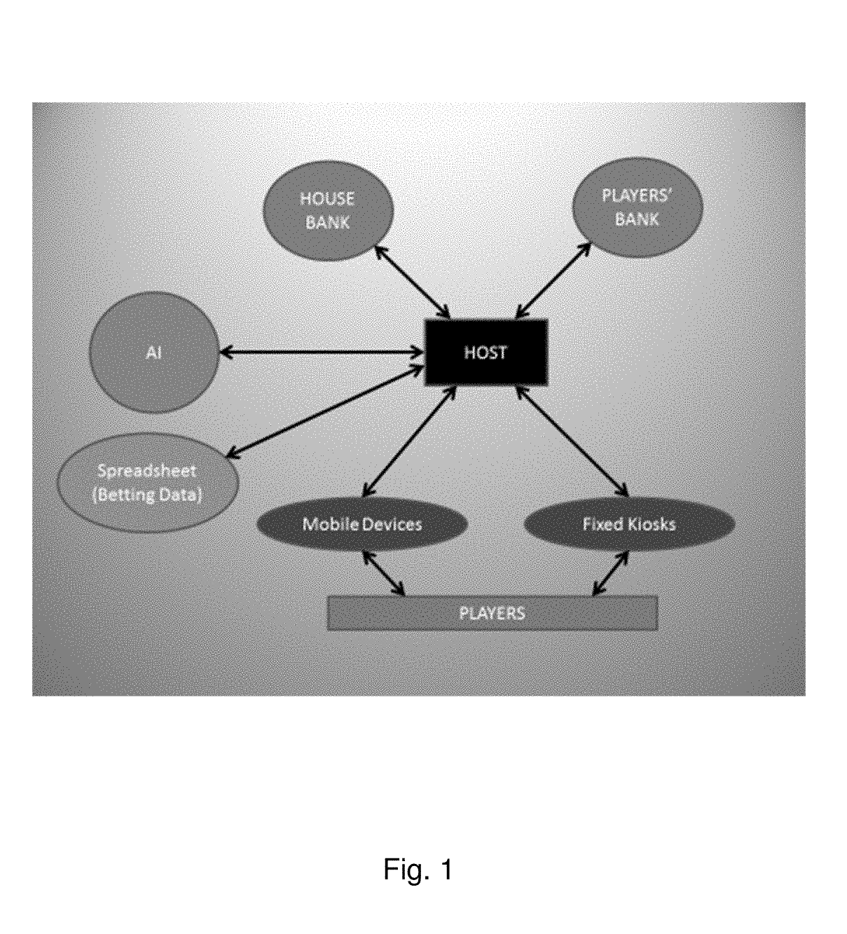

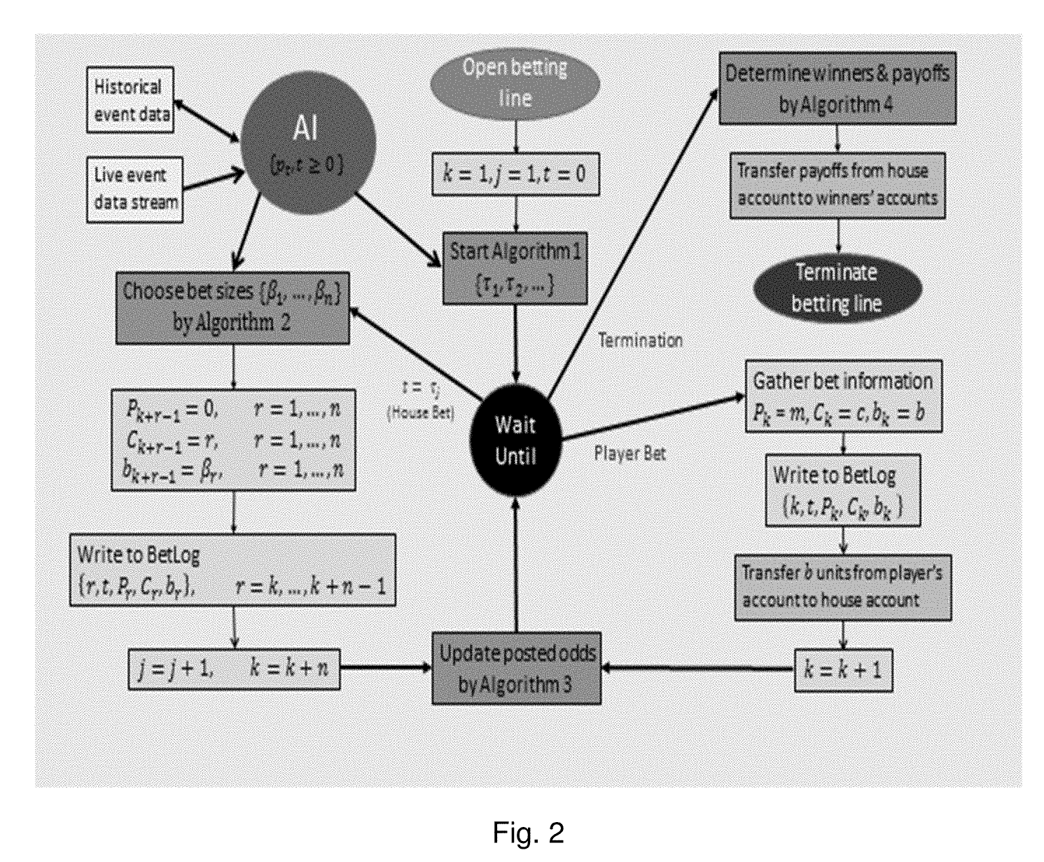

Exemplary embodiments of the present invention are illustrated in FIG. 1 and FIG. 2. A host processor is in communication a plurality of player processors, which allow players to access the betting system and enter desired bets. The player processors include devices such as mobile electronic devices (such as a smart phone that a player uses to log into the system) or fixed kiosks (FIG. 1). The house bank and players' bank refer to an account used to store and transfer credits, electronic units, tokens, or money used to placed bets. A player bet transfers the wagered amount from the player's bank account to the house's bank account. For winning player bets, a payoff amount is determined by a predetermined algorithm based on the amount wagered on the betting line and the precise time of the bet, and is transferred from the house's bank account to the players' bank account.

A detailed electronic betting spreadsheet (the BetLog) is used to keep track of betting data and communicate this data to the host processor. The host processor is also able to communicate with an artificial intelligence (AI) unit that is able to continuously estimate the real-time probabilities of a set of mutually exclusive outcomes associated with a betting (sporting) event.

Players can place bets at any time during a betting event, subject to house rules. Once a bet is made, the bet amount is transferred from the player bank account to the house's bank account and is noted on the electronic spreadsheet (FIG. 2). Player bets affect the posted payoff odds and the ultimate payoff odds.

The house can also make bets on its own behalf. The house bets influence the posted and ultimate payoff odds just like player bets. The primary purpose of the house bets is to influence those odds in a strategic manner. When the house bets, it typically bets on all choices simultaneously. The relative sizes of the house bets for each choice are determined by the AI probability estimates, coupled with a predetermined betting strategy, e.g., one that minimizes risk for the house. The times of the house bets are also determined in real time by a predetermined algorithm based on the AI feed and BetLog. The spreadsheet is updated with the house bets similar to player bets.

The posted estimated payoff odds on the choices change in time and are always good-faith estimates of the ultimate payoff odds based on a fixed algorithm, but are not guaranteed to be exact. Once the betting event terminates, the ultimate payoff odds on winning bets are determined by a fixed algorithm based on the totality of data contained in the spreadsheet constructed during the betting event. For each bet made during the betting event (players and house), the betting spreadsheet contains the bettor's identification, the time of the bet, the amount of the bet, and the betting choice. The house is entitled to the payoffs on its winning bets, so another purpose of the house bets is to make additional revenue for the house.

The following describes functions of exemplary algorithms used in one or more embodiments, such as the examples described in FIGS. 1 and 2. However, it should be noted that these examples do not limit the types of algorithms that can be used in other embodiments. Embodiments of the present invention may use algorithms provided in the given examples, or use more (or less) elaborate algorithms as necessary.

Algorithm 1 receives information from an AI feed and the BetLog and determines the points in time, {τ₁, τ₂, . . . }, when the house places bets. There are alternative ways to choose these times, and the precise parameters used can be considered house rules. One example of such an algorithm chooses τⱼ₊₁ to be the first time that the probabilities pₜ=(pₜ(1), . . . , pₜ(n)) from the AI feed differ from the probabilities at time τⱼ by more than a threshold. In other words τⱼ₊₁=inf {t>τₜ∥pₜ−pτj∥>ϵ} where ∥⋅∥ is Euclidian distance, and ϵ is the threshold.

Algorithm 2 uses the BetLog (and possibly the AI feed), and chooses bet sizes {β₁, . . . , βₙ} on the n choices when the house makes bets at time {τ₁, τ₂, . . . }. There are many ways to choose the betting amounts, and the algorithm used can be considered house rules. One simple example of such an algorithm makes a total bet of $b every time, and at time τⱼ the bet on choice r is set to βᵣ=b·p_{τj}(r), r=1, n, i.e., βᵣ is proportional to the probability choice r wins, as estimated by the AI. Note that if the house does not want to make bets of its own, it can set b=0.

Algorithm 3 uses the AI feed and BetLog to calculate the numbers used to update the posted odds whenever there is a bet (by a player or the house). There are many ways to estimate the ultimate payoff odds on the betting choices, and the algorithm used can be considered house rules. One example of such an algorithm sets the posted payoff odds for choice r to

$${\overline{𝒪}}_{r} ( t ) = \frac{{\sum }_{k} {b}_{k} {1}_{\{ {t}_{k} ∈ [ {τ}^{-} ( t ) , t ] \}}}{{\sum }_{k} {b}_{k} {1}_{\{ {t}_{k} ∈ [ {τ}^{-} ( t ) , t ] , {c}_{k} = r \}}}$$

where τ⁻(t)=max {τⱼ:τⱼ≤t}, and 1_{{A}} is 1 if A is true and 0 otherwise.

Algorithm 4 uses the BetLog to determine how much to pay winning bets after the betting line terminates. There are many ways to assign payoffs, and the algorithm used can be considered house rules. One example of such an algorithm simply sets the ultimate payoff odds for a bet made at time t on choice r to

[symbol]

ᵣ(t)= [symbol] ᵣ(t).

Another example of such an algorithm has the form

$${𝒪}_{r} ( t ) = \frac{{\sum }_{k} {b}_{k} {1}_{\{ {t}_{k} ∈ [ {τ}^{-} ( t ) , {τ}^{+} ( t ) ] \}}}{{\sum }_{k} {b}_{k} {1}_{\{ {t}_{k} ∈ [ {τ}^{-} ( t ) , {τ}^{+} ( t ) ] , {c}_{k} = r \}}}$$

Where τ⁺ (t)=min {τⱼ:τⱼ≥t}.

Additional exemplary embodiments of the present invention are described in the following examples.

### Example 1

In one embodiment of the present invention, a host computer communicates with an AI system that continuously feeds the host computer with real-time estimates of the probabilities that each betting choice (1, 2, . . . , n) will prevail for a given betting event. Preferably, the betting choices are mutually exclusive meaning that only one of the choices will win. The host computer also communicates with a network of devices (mobile devices, kiosks, etc.) that players use to monitor the posted payoff odds on the choices, place bets, and receive messages. The host computer also communicates with a “bank” where players have accounts, and a “bank” associated with the house. When players make bets, the host computer transfers money from the player accounts and deposits the bets in the house's bank account. At the same time, it updates a spreadsheet, or other electronic record, of betting activity so the players can be paid (from the house's bank account) the exact amount they are owed if they win. The data stored on the spreadsheet has a line for each bet, including the time of the bet, the amount of the bet, the betting choice, and the owner of the bet. In this embodiment the times {t₁, t₂, . . . , t_{N}} when the house places bets occur frequently.

The algorithm that determines the sequence of times in this example works as follows.
The first house bets occur at time τ₀=0, when the betting opens.
At time t the host notes {pₜ(1), . . . , pₜ(n)}, the current probabilities of winning for the n choices, as estimated by the AI.
The house bets again at the first time the probabilities from the AI differ from the probabilities from the AI the last time the house made bets. by more than a threshold amount. (The way two probability vectors are compared is house rules.) This algorithm continues until the betting event terminates.

This embodiment can be used as a general-purpose, in-game, real-money sports betting system. For example: the betting event could be a 3-game football parlay. In this case there are 8 mutually exclusive betting choices, corresponding to the 8 possible outcomes of winners and losers of the 3 games. During the 3 games, the AI continuously determines the up-to-date probabilities of the 8 possible outcomes by multiplying the current win/loss probabilities associated with each game, and communicates the results to the host. At times {t₁, t₂, . . . , t_{N}} determined by the first predetermined algorithm the house places bets on all 8 choices, where the amounts bet on the choices are exactly proportional to the current probabilities estimated by the AI.

Alternatively, the betting event could be a drive in a football game with mutually exclusive choices {Touchdown, Field Goal, Punt, Turnover}. During the drive, the AI continuously determines the probabilities of the four outcomes and communicates the results to the host. At times {t₁, t₂, . . . , t_{N}} determined by the first predetermined algorithm the house places bets on all four choices, where the amounts bet on the choices are exactly proportional to the current probabilities estimated by the AI.

The betting event could be an at-bat in a baseball game with mutually exclusive choices {single, double, triple, Home Run, Strike out, Ground out, Fly out, Walk, Other}. During the at-bat, the AI continuously determines the probabilities of the nine outcomes and communicates the results to the host. At times {t₁, t₂, . . . , t_{N}} determined by the first predetermined algorithm the house places bets on all nine choices, where the amounts bet on the choices are exactly proportional to the current probabilities estimated by the AI.

The betting event could be a half-inning in a baseball game with mutually exclusive choices {0 runs, 1 run, 2 runs, 3 runs, >3 runs}. During the at-bat, the AI continuously determines the probabilities of the five outcomes and communicates the results to the host. At times {t₁, t₂, . . . , t_{N}} determined by the first predetermined algorithm the house places bets on all five choices, where the amounts bet on the choices are exactly proportional to the current probabilities estimated by the AI.

Alternatives associated with other live events would be performed in a similar way.

### Example 2

In another embodiment of the present invention, the house places bets at the start of the betting event, at t=0, and typically will not bet after that. The initial house bets can be proportional to the probabilities estimated for the choices by the AI, or simply equal for each choice. The house maintains a detailed electronic record, such as a spreadsheet, detailing every bet made (house and players). Each line of the as a spreadsheet that includes the time of the bet, the amount of the bet, the betting choice, and the owner of the bet. The posted payoff odds at time t for choice j is Σmᵣ(t)/mⱼ(t), where mᵣ(t) is the total amount bet on choice r (players and house) up to time t. If choice j turns out to be the winning choice, then the actual odds paid for a bet on choice j at time t is the posted odds for choice j at time t, adjusted by the bet itself, i.e., (b+Σmᵣ(t))/(b+mⱼ(t)) where b is the size of the bet. In principle the player can therefore calculate the exact ultimate payoff odds on his/her bet from the posted payoff odds and the size of the bet. This preferred embodiment can be used as a social game played for “chips” that have no monetary value.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

1. A method of providing a betting system between a plurality of players and a house, wherein the betting system is based on a live event, wherein said method comprises:
a) selecting one or more betting events for the players while or before the live event is in progress, wherein each betting event is based on actions occurring during said live event;
b) opening one or more betting lines for each selected betting event before the start or after the start of the live event but before a termination event occurs with regard to the betting event, each betting line comprising two or more mutually exclusive betting choices corresponding to a finite set of possible outcomes of the selected betting event;
c) continuously estimating probabilities that each betting choice of each selected betting event will be a winning choice;
d) allowing the players an amount of time while the betting lines are open to selectively bet on the betting lines;
e) placing a first house bet on one or more betting choices of a selected betting line;
f) at one or more time periods {t₁, t₂, . . . , t_{N}}, when the estimated probabilities of the betting choices becoming the winning choice differ by more than a fixed threshold amount from probabilities estimated at a time when the most recent previous house bet was made, placing one or more additional house bets on the one or more betting choices at said time periods, wherein each house bet is in an amount that is able to be the same or different from one another, wherein the house bet amount for each betting choice is proportional to a current estimated probability of that betting choice becoming the winning choice;
g) during the time when players are allowed to bet on the betting lines, continuously calculating estimated payoff odds of each betting choice based on placed bet data of the players and the house and posting said estimated payoff odds to the players;
h) monitoring the live event until a termination event occurs with regard to the betting event;
i) terminating the betting event upon occurrence of the termination event; and
j) upon termination of the betting event, paying off winners of the one or more betting lines based on the amount wagered on the betting lines and the precise times of the bets, wherein winning house bets are paid to a house account.

2. The method of claim 1 wherein placing a house bet on one or more betting choices comprises simultaneously placing a house bet on each of the betting choices of a selected betting line.

3. The method of claim 1 wherein the house bets are placed at times periods which are determined in real time by a first predetermined algorithm based on continuously estimated probabilities that the choices are winning choices, and the amounts of the house bets at said times are determined by a second predetermined algorithm also based on said estimated probabilities.

4. The method of claim 1 wherein the posted odds on a choice (r) at a time (t) is calculated from all bets placed from a previous house betting time (tᵢ<t) up to time (t) as determined by a third predetermined algorithm; and the ultimate payoff on a winning bet placed at time (t) depends on all bets placed between said previous time (tᵢ) and a house betting time after time (t), (tᵢ₊₁>t), or when the betting event terminates, whichever occurs first, as determined by a fourth predetermined algorithm.

5. The method of claim 1 wherein the betting event is a live sports event.

6. The method of claim 1 wherein the betting event is a k-game football parlay and the betting choices are the 2^{k} possible winning and losing combinations.

7. The method of claim 1 wherein the betting event is a drive in a football game and the betting choices include touchdowns, field goals, punts, and turnovers.

8. The method of claim 1 wherein the betting event is a half-inning or at-bat in a baseball game.

9.-11. (canceled)

12. The method of claim 1 wherein the betting event is a football game, a tennis match, an eSport event, an election, or awards show.

13. The method of claim 1 wherein the house rules can specify conditions that may occur during the betting event where player bets are not accepted.

14. The method of claim 1 wherein the house bets are placed at the beginning of the betting event, and where the posted odds on choice k at time t is calculated from all bets placed up to time t by a third predetermined algorithm, and the ultimate payoff on a winning bet placed at time t is the same as the posted odds at time t, taking said bet into account by a fourth predetermined algorithm.

15. The method of claim 1 wherein an artificial intelligence (AI) monitors the live event, and estimates the probabilities that each of the betting choices will be the winning choice continuously during the betting event, and determines the time periods to place the house bets and the amount for each house bet.

16. A system for providing a betting game between a plurality of players, wherein said betting game is based on actions occurring during a live event, where said system is under the control of an administrator and comprises:
a) a host processor programmed for analyzing and processing input data, and outputting data and information relevant to the betting game; said host processor programmed to:
i) select one or more betting events for the players, wherein each betting event is based on actions occurring during said live event;
ii) open one or more betting lines for each selected betting event before the start or after the start of the live event but before a termination event occurs with regard to the betting event, each betting line comprising two or more mutually exclusive betting choices corresponding to a finite set of possible outcomes of the selected betting event;
iii) continuously estimate probabilities that each betting choice of each selected betting event will be a winning choice;
iv) allow the players an amount of time while the betting line is open to selectively bet on the betting lines;
v) at one or more time periods {t₁, t₂, . . . , t_{N}} when the estimated probabilities of the betting choices becoming a winning choice differ from estimated probabilities at a previous house betting time τⱼ by more than a fixed threshold amount, place a house bet on one or more betting choices of a selected betting line, wherein each house bet is in an amount that is able to be the same or different from one another, wherein the house bet amount for each betting choice is proportional to a current estimated probability of that betting choice becoming a winning choice;
vi) during the time when players are allowed to bet on the betting lines, continuously calculate estimated payoff odds of each betting choice based on placed bet data and posting said estimated payoff odds to the players;
vii) monitor the live event until a termination event occurs with regard to the betting event;
viii) terminate the betting event upon occurrence of the termination event; and
ix) upon termination of the betting event, pay off the one or more betting lines based on the amounts wagered on the betting lines and the precise times of the bets, wherein winning house bets are paid to a house account;
b) a plurality of player processors interactively connected to said host processor, said player processor able to send and receive data to said host processor;
c) a display and interface device operatively associated with each said player processor, said display and interface device able to display data received from said player processor, and able to send betting instructions entered by the player to said host processor through said player processor;
d) an administrative processor interactively connected to said host processor, said administrative processor able to send commands to said host processor; and
e) an administrative display and interface device operatively associated with said administrative processor, said administrative display and interface device able to display data received from said host processor, and able to send commands entered by the administrator to said host processor;
wherein said commands control when said host processor opens said betting line, and when said host processor makes house bets, and terminates said betting line.

17. The system of claim 16 further comprising an artificial intelligence (AI) able to automatically estimate the probabilities that each of the betting choices will be the winning choice continuously during the betting event, and determines the time periods to place the house bets and the amount for each house bet.

18. The system of claim 17 further comprising an AI able to collect data from one or more of a historical event database, the live event, and placed bets, and utilize said collected data to continuously estimate the probabilities that each of the betting choices will be the winning choice, and transmit the probability estimates to the host processor.

19. The method of claim 15 wherein the AI has access to a historical event database and estimates the probabilities that each of the betting choices will be the winning choice based on historical outcomes of similar events.

20. The method of claim 3 further comprising:
placing the first house bet at time τ₀=0 when the betting line opens;
continuously estimating the probabilities of the betting choices pᵣ=(pᵣ(1), . . . , pᵣ(n)) becoming the winning choice, where n is a number of betting choices; and
placing additional one or more house bets at a time τⱼ₊₁, where the probabilities of the betting choices becoming the winning choice at times τⱼ and τⱼ₊₁ differ from one another by more than threshold ϵ according to the formula:
τⱼ₊₁=inf{t>τⱼ:∥pₜ−p_{τj}∥>ϵ}, where ∥⋅∥ is Euclidian distance.

21. The method of claim 20 wherein the house bet amount βᵣ for each betting choice r at time τ_{f} is determined by the formula βᵣ=b·p_{τj} (r), r=1, . . . , n, where b is the total amount bet.

22. The method of claim 4 wherein the posted payoff odds at time t for choice j are determined by the formula Σmᵣ(t)/mⱼ(t)−1, where mᵣ(t) is a total amount bet on choice r, starting from the previous house betting time up to time t.

23. The method of claim 22 wherein the ultimate payoff odds on a winning bet placed for choice j at time t is given by the formula Σmᵣ(tᵢ)/mⱼ(tᵢ)−1, where tᵢ is a next house betting time after t.
